(19) United States
(12) Patent Application Publication
(10) Pub. No.: US 2025/0168930 A1
(43) Pub. Date: May 22, 2025

(54) HEATING ELEMENT FOR ELECTRONIC CIGARETTE

(71) Applicant: ASPIRE NORTH AMERICA LLC, Los Angeles, CA (US)

(72) Inventor: Tuanfang LIU, Shenzhen (CN)

(73) Assignee: ASPIRE NORTH AMERICA LLC, Los Angeles, CA (US)

(21) Appl. No.: 19/030,963

(22) Filed: Jan. 17, 2025

Related U.S. Application Data
(63) Continuation of application No. 17/351,163, filed on Jun. 17, 2021.

(30) Foreign Application Priority Data
Dec. 21, 2020 (CN) 202011517990.8
Dec. 21, 2020 (CN) 202023094079.9

(51) Int. Cl. H05B 1/02; A24F 40/10; A24F 40/46; A24F 40/485; F22B 1/28

(52) U.S. Cl. CPC H05B 1/0297; A24F 40/10; A24F 40/46; A24F 40/485; F22B 1/284

(57) ABSTRACT

A heating element, including a body and a heating wire. The body includes a bottom surface and the heating wire is attached to the bottom surface of the body. The body includes a central through hole surrounded by the heating wire. The heating wire includes a metal band, and the metal band is in the shape of a closed circle including a first connecting part, a second connecting part, a first heating part, and a second heating part. The first heating part and the second heating part are parallel to each other and both include continuous U-bends in opposite directions alternately, and arms of the continuous U-bends are straight metal bands parallel to each other. At least two pins are connected to the first connecting part and the second connecting part, respectively.

### CROSS-REFERENCE TO RELATED APPLICATIONS

This application is a continuation-in-part of U.S. application Ser. No. 17/351,163 filed Jun. 17, 2021, now pending, and claims foreign priority to Chinese Patent Application No. 202011517990.8 filed Dec. 21, 2020, and to Chinese Patent Application No. 202023094079.9 filed Dec. 21, 2020. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to a heating element for an electronic cigarette.

Conventionally, a heating element includes a cylindrical base including one or two through holes, and corresponding heating wires are vertically disposed in the through holes, respectively. To fix the heating wires in the through holes, the heating element further includes a support and an air tube. This increases the installation and material costs. In addition, the heating element has low heating power, low heat generation, and low vapor volume, and cannot meet the demand of users for large vapor volume.

### SUMMARY

The disclosure provides a heating element, comprising a body and a heating wire; the body comprises a bottom surface and the heating wire is attached to the bottom surface of the body; the body comprises a central through hole surrounded by the heating wire; the heating wire comprises a metal band, and the metal band is in the shape of a closed circle comprising a first connecting part, a second connecting part, a first heating part, and a second heating part; two ends of the first heating part are respectively connected to the first connecting part and the second connecting part; two ends of the second heating part are respectively connected to the first connecting part and the second connecting part; the first heating part and the second heating part are parallel to each other and both comprise continuous U-bends in opposite directions alternately, and arms of the continuous U-bends are straight metal bands parallel to each other; when being electrified, the first heating part and the second heating part are configured to produce heat; and at least two pins are connected to the first connecting part and the second connecting part, respectively.

In a class of this embodiment, the heating wire is a flat structure and further comprises a central hollow portion formed by the first connecting part, the second connecting part, the first heating part, and the second heating part; and the central through hole is disposed in the central hollow portion.

In a class of this embodiment, the body comprises an upper surface comprising a plurality of grooves for removal of air bubbles formed in the process of loading e-liquid.

In a class of this embodiment, the central through hole is in the shape of a circle, ellipse, triangle, quadrilateral, polygon, or mesh, and is configured to guide vapor.

In a class of this embodiment, the body is in the shape of a cylinder, an ellipsoid, a runway, a hemisphere, a cone, a bowl, a triangle, a quadrilateral, or a polygon, and the body comprises quartz, crystal, mica, agate, or jade.

The disclosure also provides an atomizer comprising the aforesaid heating element.

### BRIEF DESCRIPTION OF THE DRAWINGS

FIG. 1 is an exploded view of a heating element according to one embodiment of the disclosure;

FIG. 2 is a schematic diagram of a heating element according to one embodiment of the disclosure; and

FIG. 3 is a sectional view of a heating element according to one embodiment of the disclosure.

### DETAILED DESCRIPTION

To further illustrate, embodiments detailing a heating element for an electronic cigarette are described below. It should be noted that the following embodiments are intended to describe and not to limit the disclosure.

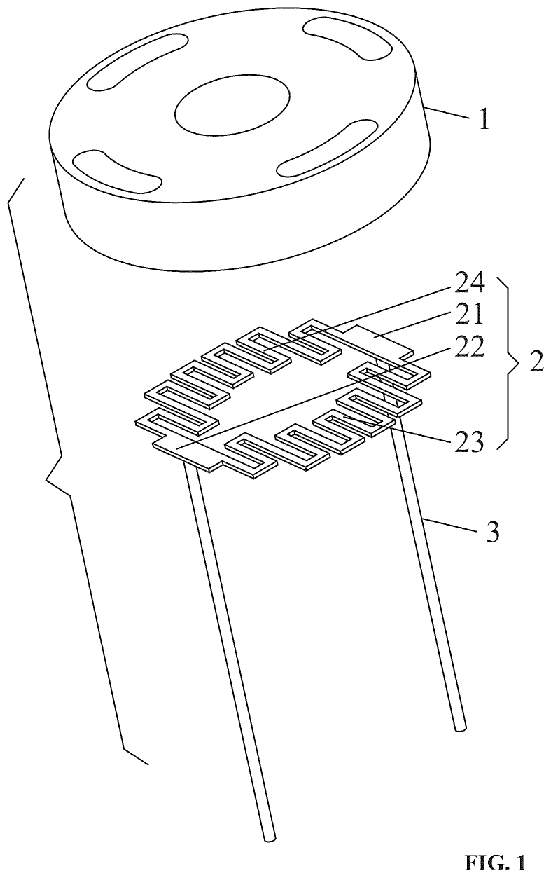

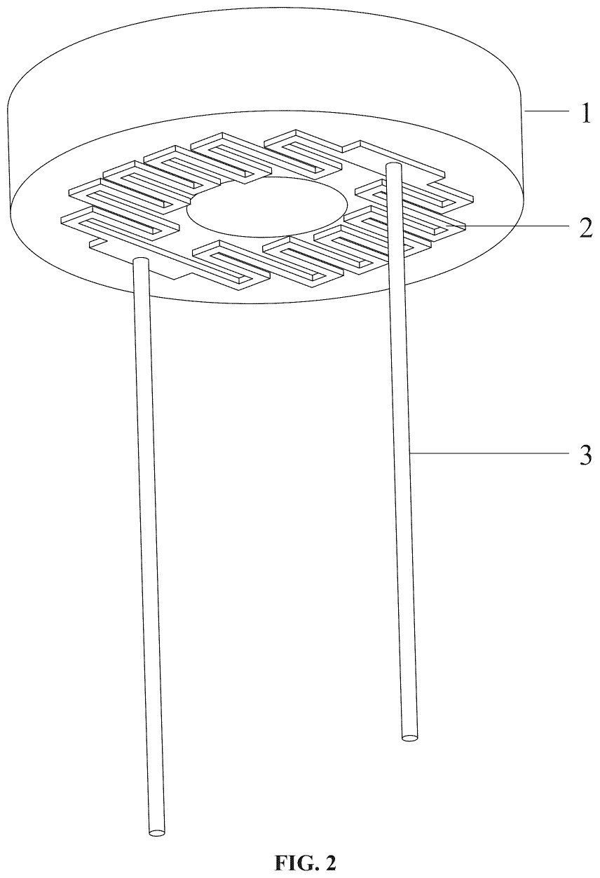

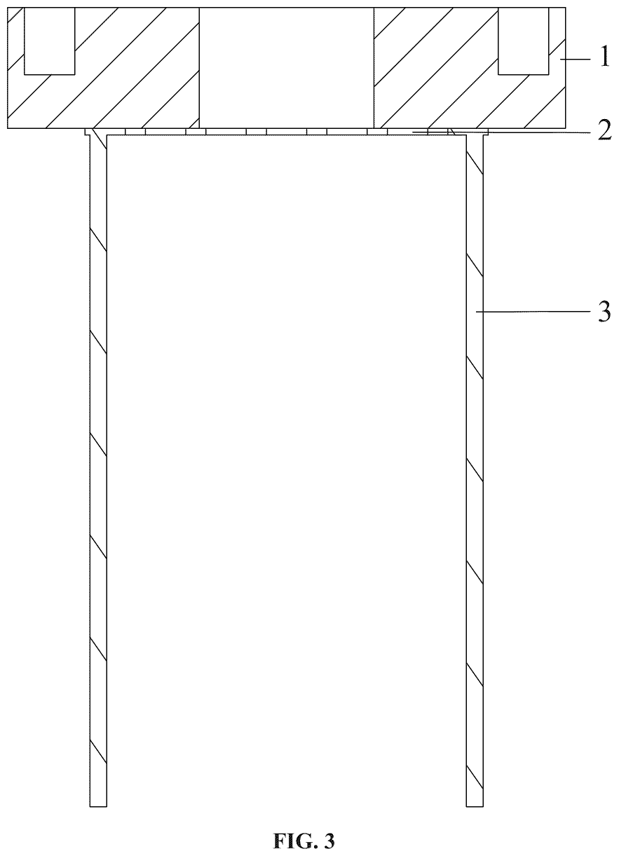

As shown in FIGS. 1-3, the disclosure provides a heating element comprising a body 1 and a heating wire 2. The body is in the shape of a cylinder and comprises a central through hole surrounded by the heating wire. The heating wire comprises a metal band, and the metal band is in the shape of a closed circle comprising a first connecting part 21, a second connecting part 22, a first heating part 23, and a second heating part 24; two ends of the first heating part 23 are respectively connected to the first connecting part 21 and the second connecting part 22; two ends of the second heating part 24 are respectively connected to the first connecting part 21 and the second connecting part 22; the first heating part 23 and the second heating part 24 are parallel to each other and both comprise continuous U-bends in opposite directions alternately, and arms of the continuous U-bends are straight metal bands parallel to each other; when being electrified, the first heating part 23 and the second heating part 24 are configured to produce heat; and at least two pins 3 are connected to the first connecting part 21 and the second connecting part 22, respectively.

The heating wire 2 is a flat structure and further comprises a central hollow portion formed by the first connecting part 21, the second connecting part 22, the first heating part 23, and the second heating part 24. The central through hole is disposed in the central hollow portion.

The heating wire 2 is disposed on the bottom surface of the body 1. When in use, the heating element is disposed in an atomizer and the heating wire 2 is electrified to produce heat. The heat is transferred to the body 1 to atomize the e-liquid to produce vapor. A tube is inserted into the central through hole to guide the vapor. Specifically, the air is introduced via the central through hole into the body to drive the produced vapor to flow from the tube to an air passage for user's inhaling.

In certain embodiments, the body 1 comprises quartz, crystal, mica, jade or the like. The body 1 is a cylinder, a square, a hemisphere, a cone or a polygon. The central through hole is in the shape of a circle, ellipse, triangle, quadrilateral, polygon, or mesh.

The following advantages are associated with the heating element of the disclosure:

1. The shape of the heating element is designed as a cylinder comprising a central through hole. Upon assembly of an atomizer, a tube is fixed in the central through hole of the heating element. The heating element is easily disposed in the atomizer through the tube, and the air enters the heating element and vapor flows out the heating element via the tube, no need to design a support for the heating element and a guide tube as a conventional atomize does.

2. The heating wire is a flat structure comprising a metal wire having continuous U-bends in opposite directions alternately in one plane and is disposed on the bottom surface of the body. Compared with a conventional heating wire which is vertically wound in the through hole of the body, the heating element of the disclosure has a larger surface area and higher atomization efficiency.

3. The body comprises an upper surface comprising a plurality of grooves for removal of air bubbles formed in the process of loading e-liquid. Thus, an atomizer comprising the heating element has a fast e-liquid loading and produces more vapor.

It will be obvious to those skilled in the art that changes and modifications may be made, and therefore, the aim in the appended claims is to cover all such changes and modifications.

What is claimed is:

1. A heating element, comprising a body and a heating wire; wherein, the body comprises a bottom surface and the heating wire is attached to the bottom surface of the body; the body comprises a central through hole surrounded by the heating wire; the heating wire comprises a metal band, and the metal band is in the shape of a closed circle comprising a first connecting part, a second connecting part, a first heating part, and a second heating part; two ends of the first heating part are respectively connected to the first connecting part and the second connecting part; two ends of the second heating part are respectively connected to the first connecting part and the second connecting part; the first heating part and the second heating part are parallel to each other and both comprise continuous U-bends in opposite directions alternately, and arms of the continuous U-bends are straight metal bands parallel to each other; when being electrified, the first heating part and the second heating part are configured to produce heat; and at least two pins are connected to the first connecting part and the second connecting part, respectively.

2. The heating element of claim 1, wherein the heating wire is a flat structure and further comprises a central hollow portion formed by the first connecting part, the second connecting part, the first heating part, and the second heating part; and the central through hole is disposed in the central hollow portion.

3. The heating element of claim 1, wherein the body comprises an upper surface comprising a plurality of grooves for removal of air bubbles formed in the process of loading e-liquid.

4. The heating element of claim 1, wherein the central through hole is in the shape of a circle, ellipse, triangle, quadrilateral, polygon, or mesh, and is configured to guide vapor.

5. The heating element of claim 1, wherein the body is in the shape of a cylinder, an ellipsoid, a runway, a hemisphere, a cone, a bowl, a triangle, a quadrilateral, or a polygon, and the body comprises quartz, crystal, mica, agate, or jade.

6. An atomizer, comprising the heating element of claim 1.
